(19) United States
(12) Patent Application Publication
(10) Pub. No.: US 2008/0025018 A1
(43) Pub. Date: Jan. 31, 2008

(54) WATER BOTTLE-CONTAINER-FLASHLIGHT APPARATUS

(76) Inventor: Bonni Shevin Sandy, Morton Grove, IL (US)

Correspondence Address: PERKINS COIE LLP, POST OFFICE BOX 1208, SEATTLE, WA, 98111-1208, US

(21) Appl. No.: 11/534,525

(22) Filed: Sep. 22, 2006

(51) Int. Cl. F21L 4/00

(52) U.S. Cl. 362/157

(57) ABSTRACT

A multipurpose apparatus useful for carrying liquid, providing storage and emitting light includes a vessel with a removable drinking cap and carrying handle. The bottom end of the vessel is detachably fastened to a removable storage container, which is detachably fastened to a removable flashlight. The storage container may also include a removable lid for use without the vessel.

### BACKGROUND

The field of the invention relates broadly to multipurpose storage and liquid carrying devices which typically can be used in connection with a light emitting source.

Traditional multipurpose containers or bottles useful for storing different materials often include multiple receptacles with dividing walls for keeping primary and secondary materials separated from each other. For example, pharmaceutical kits exist which may include a container, for holding oral dosage units of drugs, which serves as an attachment to the underside of a water bottle. Accordingly, water and pharmaceuticals are conveniently contained but separated in a single apparatus. Such multipurpose containers provide the convenience of keeping drugs and beverages in close proximity in a single apparatus for easy access when traveling or in any setting.

Such multipurpose containers are commonly used and desirable in situations where space is limited and the number of separate articles is preferably minimized. Currently, the number of functions provided by such containers is limited and improved multipurpose containers serving a greater variety of needs and functions are needed.

### SUMMARY OF THE INVENTION

A multipurpose apparatus is provided which includes a vessel with a removable cap fastened to the top end of the vessel. The apparatus may also include a removable storage container connected at its top end to the bottom end of the vessel, and a removable flashlight connected to the bottom end of the storage container. The multipurpose apparatus provides an all in one light emitting, storage and carrying means.

### BRIEF DESCRIPTION OF THE DRAWINGS

In the drawings, the same element number indicates the same element in each of the views.

FIG. 1 is an exploded perspective view of a water bottle-storage container-flashlight apparatus where the removable storage container and flashlight are connected to one another.

FIG. 2 is an exploded perspective view of the apparatus shown in FIG. 1 showing all parts spaced apart form each other.

FIG. 3 is an exploded perspective view of a removable storage container with attached flashlight of the apparatus shown if FIG. 1, and a removable lid.

### DETAILED DESCRIPTION OF THE DRAWINGS

A multipurpose apparatus useful for carrying liquid, providing storage for various objects and compositions, and emitting light has at least three parts. A vessel having a removable cap forms one part. A removable storage container forms a second part. A removable flashlight disk forms a third part. The vessel and storage container may include screwable thread for detachably fastening the storage container to the vessel. The flashlight disk may also contain screwable thread for detachably fastening the flashlight disk to the bottom end of the storage container. The multipurpose apparatuses described herein may be used for carrying various liquids as well as for storing items such as food products and pharmaceuticals, while also providing a convenient light source. Such apparatuses are useful for traveling, camping or any activity where it is desirable to minimize the weight and number of different containers or articles needed and where easy access to multiple amenities is advantageous.

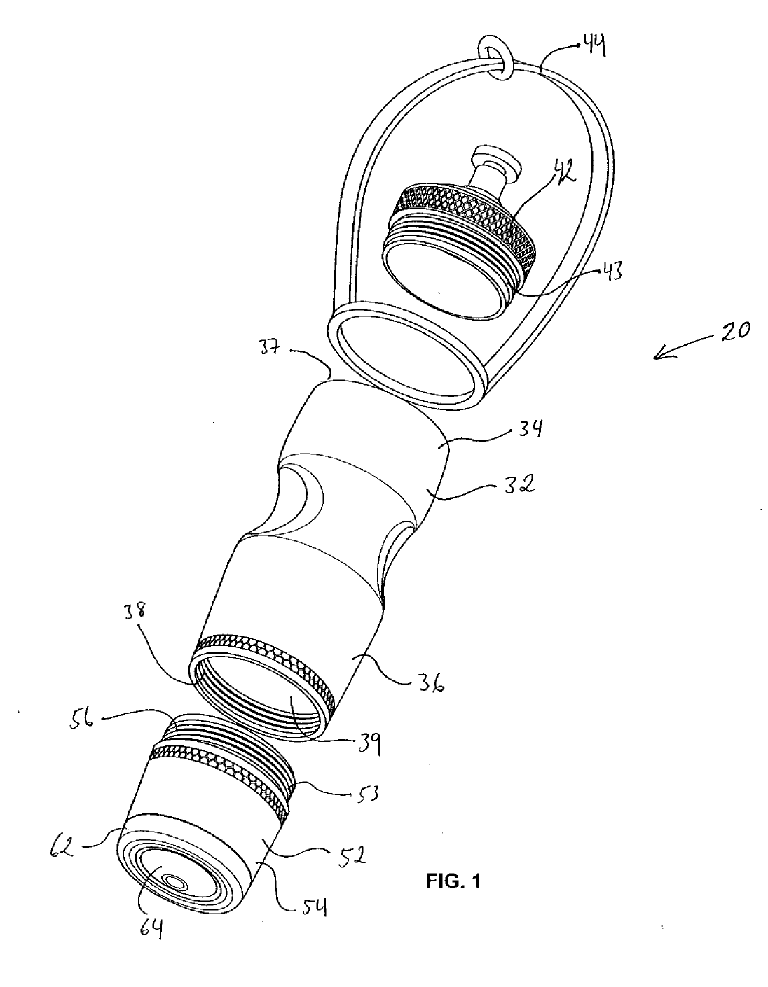

Turning now to the drawings, as shown in FIG. 1, a multipurpose apparatus 20 has a vessel 32. The vessel 32 has a top end 34, a bottom end 36 and a bottom surface 39. Screwable threads 37, 38 may be provided on the inner or outer surface of the vessel 32 at the top end 34 and/or bottom end 36. A removable drinking cap 42 may be fastened to the top end 34 of the vessel 32. Screwable threads 43 may be provided on the bottom of the removable drinking cap 42 to securely fasten the drinking cap 42 onto the top end 34 (having complementary screwable threads 37) of the vessel 32 and to permit easy detachment of the drinking cap 42 from the top end 34 of the vessel 32. A carrying handle 44, useful for holding or carrying the multipurpose apparatus 20, may also be provided. The carrying handle 44 may be connected or attached between the removable drinking cap 42 and the top end 34 of the vessel 32. In one embodiment the vessel 32 may be a water bottle or other similarly shaped hollow device suitable for carrying fluid or liquid. Also, the drinking cap 42 may include any suitable cap or lid having an opening, valve, spout, etc. for releasing a liquid or fluid.

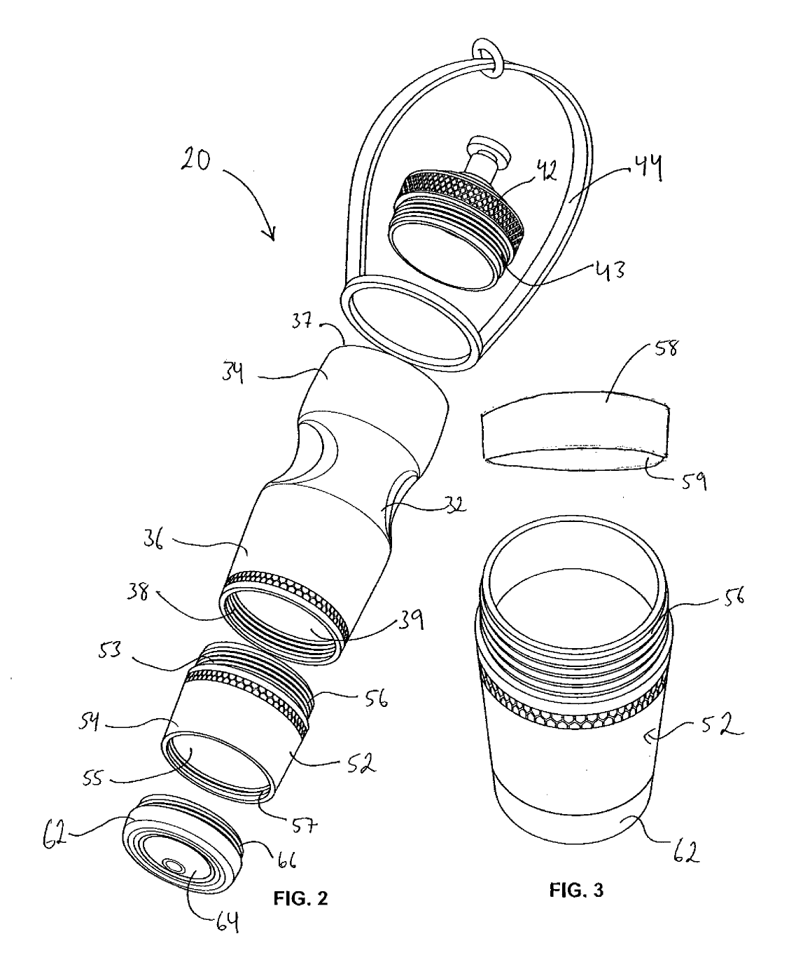

As shown in FIG. 2, the removable storage container 52 includes a top end 53, a bottom end 54 and a bottom surface 55. Screwable threads 56, 57 may be provided on the inner or outer surface of the storage container 52 at the top end 53 and/or bottom end 54 to permit secure attachment of the storage container 52 onto the bottom end 36 (having complementary screwable threads 38) of the vessel 32 and to permit easy detachment of the storage container 52 from the bottom end 36 of the vessel 32. The storage container 52 is preferably hollow and cylindrical in shape having dimensions suitable for storing various solid and liquid compositions and for securely fastening to the bottom end 36 of the vessel 32 without leakage or spillage of such compositions. For example, the storage container 52 may hold pharmaceuticals (serving as a pillbox) or various types of food products.

As shown in FIG. 3, in one embodiment, the storage container may be provided with a removable lid 58. The removable lid 58 may be provided with screwable threads for permitting secure attachment of the removable lid 58 onto the top end 53 (having complementary screwable threads 56) of the storage container 52 and for permitting easy detachment of the lid 58 from the storage container 52.

As shown in FIG. 2, the removable flashlight disk 62 may include a lens 64. Screwable threads 66 may be provided on the inner or outer surface of the flashlight disk 62 for securely fastening the flashlight disk 62 onto the bottom end 54 (having complementary screwable threads 57) of the storage container 52 and to permit easy detachment of the flashlight disk 62 from the storage container 52. The flashlight disk 52 may include an LED. The flashlight disk 52 may also include a battery or any other suitable powering means for powering the light.

In another embodiment, textured grip bands may optionally be provided on the outer surface of vessel 32, storage container 52 or flashlight disk 62 to permit easy attachment or detachment of the respective parts from one another. The drinking cap 42 may also have a textured grip on its outer surface facilitating easy attachment and removal to and from the vessel 32.

In use, the top end 34 of the vessel 32 may be detachably fastened to the removable drinking cap 42 by screwable threads 37, 43 or by friction contact between the top end 34 of the vessel 32 and the removable drinking cap 42 or by any other suitable fastening means. The carrying handle 44 may be connected between the top end 34 of the vessel 32 and the drinking cap 42, e.g., by being compressed between the top end 34 of the vessel 32 and the drinking cap 42. The vessel 32 with removable drinking cap 42 can function alone, e.g., as a water bottle, without attachment of the removable storage container 52 or removable flashlight disk 62 thereto.

In another embodiment the bottom end 36 of the vessel 32 with removable drinking cap 42 and carrying handle 44 can be detachably fastened to the top end 53 of the removable storage container 52 by screwable thread, friction contact between the vessel 32 and removable storage container 52, or by any other suitable fastening means. As such, the vessel 32 with attached storage container 52 can be used together for carrying liquid and/or storing various compositions without attachment of the removable flashlight disk 62 to the bottom end 54 of the storage container 52. Alternatively, the removable flashlight disk can be detachably fastened to the bottom end 54 of the storage container 52 by screwable thread, friction contact between the storage container 52 and the flashlight disk 62, or by any other suitable fastening means, thereby providing a convenient all in one light emitting, storage and liquid carrying means.

In another embodiment, as shown in FIG. 3, the removable storage container 52 may include a removable lid 58 which can be detachably fastened to top end 53 of the storage container 52 by screwable thread, friction contact between the storage container 52 and removable lid 58, or by any other suitable fastening means. As such, the storage container 52 provides a convenient means for storing various liquids or compositions without being attached to the vessel 32. The removable flashlight disk 62 may optionally be detachably fastened to the bottom end 54 of the storage container 52, as described above, providing a convenient light source in connection with a storage means. Alternatively, the removable flashlight disk 62 may not be attached to the storage container 52 and the storage container 52 with removable lid 58 may be used alone as a suitable storage means or drinking cup.

Thus novel apparatuses and methods have been described. Various changes and modifications may of course be made without departing from the spirit and scope of the invention. The invention, therefore, should not be limited, except to the following claims, and their equivalents.

1. A multipurpose apparatus comprising:
a vessel having a top end and a bottom end;
a removable cap attached to the top end of said vessel;
a removable storage container having a top end and bottom end, wherein the top end of the storage container is connected to the bottom end of said vessel; and
a removable flashlight connected to the bottom end of said storage container.

2. The apparatus of claim 1 wherein at least one of the vessel, the storage container, the drinking cap or the flashlight disk are provided with screwable thread.

3. The apparatus of claim 2 wherein the screwable thread is provided on an inner or outer surface of the vessel, storage container, drinking cap and flashlight disk.

4. The apparatus of claim 1 wherein the removable flashlight comprises a lens.

5. The apparatus of claim 4, wherein the removable flashlight further comprises an LED.

6. The apparatus of claim 1, wherein at least one textured grip band is provided on the outer surface of at least one of the vessel, storage container, drinking cap or flashlight.

7. The apparatus according to claim 1, wherein said storage container is a pillbox suitable for containing one or more pharmaceutical compounds.

8. The apparatus according to claim 1, wherein said storage container is suitable for containing one or more food products.

9. A water bottle-storage container-flashlight apparatus comprising:
a water bottle having a top end and a bottom end;
a removable drinking cap attached to the top end of said water bottle;
a handle for carrying the apparatus connected between the drinking cap and water bottle;
a removable storage container having a top end and bottom end, the top end of the storage container is connected to the bottom end of the water bottle; and
a removable flashlight disk connected to the bottom end of said storage container.

10. The apparatus according to claim 9, wherein said storage container is a pillbox suitable for containing one or more pharmaceutical compounds.

11. The apparatus according to claim 9, wherein said storage container is suitable for containing one or more food products.

12. The apparatus of claim 9, wherein the removable flashlight disk further comprises an LED.

13. A water bottle-storage container-flashlight apparatus comprising:
a means for carrying liquid;
a means for capping a water bottle detachably coupled to said means for carrying liquid;
a means for carrying the apparatus connected between said means for carrying liquid and said means for capping a water bottle;
a means for storage detachably coupled to said means for carrying liquid; and
a means for emitting light detachably coupled to said means for storage.
